(19) United States
(12) Patent Application Publication
(10) Pub. No.: US 2017/0344570 A1
(43) Pub. Date: Nov. 30, 2017

(54) LINEAR TAPE FILE SYSTEM SELECTIVE FILE AND DIRECTORY TAPE MOUNTING

(71) Applicant: International Business Machines Corporation, Armonk, NY (US)

(72) Inventors: Atsushi Abe, Kanagawa-ken (JP); Tohru Hasegawa, Tokyo (JP); Masayuki Iwanaga, Urayasu-si (JP); Yutaka Oishi, Kanagawa (JP)

(21) Appl. No.: 15/162,825

(22) Filed: May 24, 2016

(51) Int. Cl. G06F 17/30; G11B 5/008

(52) U.S. Cl. CPC G06F 17/30106; G11B 5/00813

(57) ABSTRACT

An approach for optimized selective file and directory tape mounting based on a Linear Tape File System (LTFS). A selective LTFS mount receives LTFS Index metadata and search inputs for searching for files and directories. The selective LTFS mount parses the LTFS Index metadata into metadata elements to identify file metadata and associated directory metadata, date metadata and file structure metadata. The selective LTFS mount identifies selective files by searching at least one of the file metadata, the directory metadata and the date metadata based on matching the search inputs. The selective LTFS mount responds to identifying the selective files by creating selective file structure results based on combining the selective files, the directory metadata, the date metadata and the file structure metadata, respectively. The selective LTFS mount stores the selective file structure results in mount memory and mounts the selective file structure results, for access.

### BACKGROUND OF THE INVENTION

The present application relates generally to magnetic tape file systems and method and more specifically to selectively mounting files and/or directories for linear tape file systems.

Linear Tape File System (LTFS) refers to both the format of data recorded on magnetic tape media and the implementation of specific software that uses this data format to provide a file system interface to data stored on magnetic tape. The LTFS format is a self-describing magnetic tape format, by Storage Networking Industry Association (SNIA) LTFS Technical Work Group, to meet magnetic tape archiving requirements. The LTFS Format specification defines the organization of data and metadata on magnetic tape, where the files are stored in a hierarchical directory structure. Data tapes written in the LTFS Format can be used independent of any external database or storage system to allow direct access to file content data and file metadata. The LTFS format makes it possible to implement software that presents a standardized file system view of the data stored in the magnetic tape media. The LTFS file system view can make accessing files stored on the LTFS formatted media similar to accessing files stored on other forms of storage media such as disk or removable drives.

When the tape medium is initialized/formatted in LTFS, the tape medium is divided into two partitions for use. One of the two partitions is referred to as the Index Partition (IP) and the other is referred to as the Data Partition (DP). When a user uses an LTFS system for writing onto the tape medium, in addition to the content of the file itself being written to the DP, portions of metadata, (e.g., the LTFS Index), is written to the IP. The LTFS Index metadata can comprise information such as, but not limited to, Universally Unique Identifier (UUID) used for identifying the file, the name of the file and the date of the creation of the file. Further, the metadata can be organized in formats such as, but not limited to, Extensible Markup Language (XML). LTFS writes an LTFS Index that comprises all the file and directory meta-data for the LTFS Volume to the IP where the index is a snapshot representation of the entire content of the LTFS Volume at a given point in time. Any alteration of an LTFS Volume shall record a complete snapshot of the entire content of the LTFS Volume. When a file is written (or overwritten), LTFS writes the file content to the tape medium by appending new data to the end of existing data in the DP (e.g., unused space toward the end of the tape media). After the write operation completes, the LTFS Index metadata is not automatically written to the tape medium until a synchronization or “sync” operation is performed. A “sync” can be executed with a range of timings such as, but not limited to, at LTFS system startup, periodic durations, closing a file and during unmounting (e.g., dismounting) tape media.

### SUMMARY

As disclosed herein, a method for optimized selective file and directory tape mounting based on a Linear Tape File System (LTFS), the method comprising: receiving, by a selective LTFS mount, LTFS Index metadata and one or more search inputs for searching for one or more files and directories; parsing, by the selective LTFS mount, the LTFS Index metadata into one or more metadata elements to identify one or more file metadata and associated one or more directory metadata, one or more date metadata and one or more file structure metadata; identifying, by the selective LTFS mount, one or more selective files by searching at least one of the one or more file metadata, the one or more directory metadata and the one or more date metadata based on matching the one or more search inputs; responsive to identifying the one or more selective files, creating, by the selective LTFS mount, one or more selective file structure results based on combining the one or more selective files, the one or more directory metadata, the one or more date metadata and the one or more file structure metadata, respectively; storing, by the selective LTFS mount, the one or more selective file structure results in mount memory and mounting, by the selective LTFS mount, the one or more selective file structure results, for access. A computer system and a computer program product corresponding to the above method are also disclosed herein.

### BRIEF DESCRIPTION OF THE DRAWINGS

FIG. 1 illustrates a functional block diagram of a computing environment, in accordance with an embodiment of the present invention;

FIG. 2 illustrates a flowchart of LTFS selective file and directory tape mounting, in accordance with an embodiment of the present invention;

FIG. 3A illustrates physical tape media organization with selective file index mounting, in accordance with an embodiment of the present invention;

FIG. 3B illustrates a comparison of LTFS tape media file structure and LTFS selective file/directory tape mounted structure, in accordance with an embodiment of the present invention; and

FIG. 4 illustrates a block diagram of components of the server and/or the computing device, in accordance with an embodiment of the present invention.

### DETAILED DESCRIPTION

Embodiments of the present invention can reduce LTFS mount time by selectively mounting tape media file/directory data. Mounting tape medium/media refers to making the tape media accessible and providing a group of files in a file system structure of the tape media accessible to a user or user group. At mount-time, the LTFS software reads the current LTFS Index metadata from the Index Partition (IP) and builds an in-memory/system memory structure representing all of the directories and files stored on the media. Embodiments of the present invention can parse the LTFS Index metadata contents based on received search input (e.g., files/directories) and/or parameters (e.g., data range, wild cards) to limit mounting of LTFS media to one or more files/directories during the mounting process.

As part of LTFS tape mounting action, a selective file/directory structure is copied toward system memory to display hierarchical directory information comprising data in LTFS Index metadata such as, but not limited to, file name, file timestamps, file permissions and file size. Further, the LTFS Index metadata structure comprises the location on the Data Partition (DP) for each data extent (e.g., physical tape media location range) that stores portions of select file content. When a file is read by a requesting application, LTFS software causes the tape drive to seek to the start of the relevant data extents and reads the data from the tape media.

It should be noted that embodiments of the present invention can operate in a read only mode which does not activate a sync operation during an unmount action and/or other event and the selectively mounted files/directories do not overwrite the existing LTFS Index metadata on the LTFS media IP. Read only usage can be a preferred operation mode in many scenarios. For example, a range of security camera data can be selectively mounted for viewing where the security camera data would be anticipated as a read-only usage. In other embodiments of the present invention, a modified sync action can be performed where changed file information from selective file/mounted information can replace portions of the received LTFS Index metadata to create an updated and complete LTFS Index metadata (e.g., a second LTFS Index metadata) for overwriting the existing LTFS Index metadata on the LTFS media IP and/or LTFS media DP.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

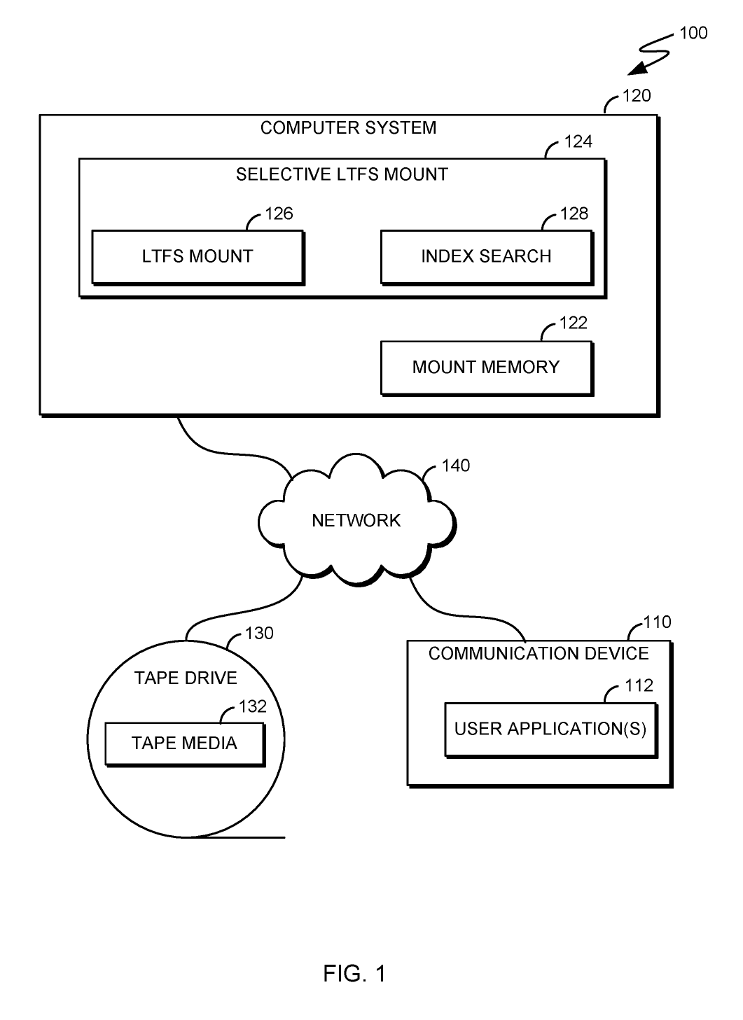

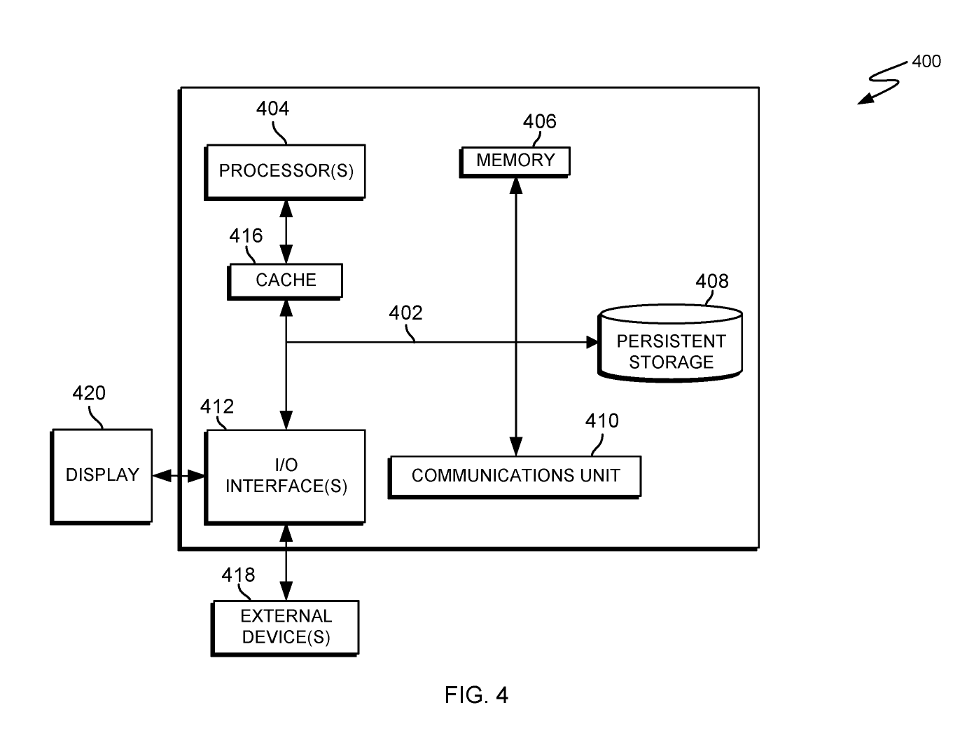

FIG. 1 illustrates a functional block diagram of a computing environment 100, in accordance with an embodiment of the present invention. Computing environment 100 comprises COMMUNICATION DEVICE 110, COMPUTER SYSTEM 120 and TAPE DRIVE 130, interconnected via NETWORK 140. COMMUNICATION DEVICE 110 and COMPUTER SYSTEM 120 can be desktop computers, laptop computers, specialized computer servers, or the like. In certain embodiments, COMMUNICATION DEVICE 110, COMPUTER SYSTEM 120 and TAPE DRIVE 130 represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110, COMPUTER SYSTEM 120 and TAPE DRIVE 130 are representative of any electronic devices, or combination of electronic devices, capable of executing computer readable program instructions, as described in detail with regard to FIG. 4.

In one embodiment of the present invention, COMMUNICATION DEVICE 110 comprises USER APPLICATION(S) 112. USER APPLICATION(S) 112 can be a plurality of USER APPLICATION(S) 112 within COMMUNICATION DEVICE 110. USER APPLICATION(S) 112 can be an application used to perform operations such as, but not limited to, operation of selective LTFS mounting, viewing and exploring mounted file/directory structures from LTFS tape media within computing environment 100. In embodiments of the present invention, USER APPLICATION(S) 112 can comprise any combination of commercial or custom devices and/or software products associated with operating selective LTFS tape mounting.

NETWORK 140 can be, for example, a local area network (LAN), a wide area network (WAN) such as the Internet, or a combination of the two, and include wired, wireless, or fiber optic connections. In general, NETWORK 140 can be any combination of connections and protocols that will support communications between COMMUNICATION DEVICE 110, COMPUTER SYSTEM 120 and TAPE DRIVE 130, in accordance with an embodiment of the present invention.

In one embodiment of the present invention, TAPE DRIVE 130 comprises TAPE MEDIA 132. TAPE DRIVE 130 can be a plurality of TAPE DRIVES 130 that can operate LTFS formatted tape media. In embodiments of the present invention, TAPE DRIVE 130 can comprise any combination of commercial or custom devices and/or software products associated with operating LTFS tape media.

In one embodiment of the present invention, TAPE MEDIA 132 can be a plurality of TAPE MEDIAS 132 within TAPE DRIVE 130. TAPE MEDIA 132 can be physical LTFS formatted tapes in forms such as, but not limited to, cartridges and tape reels. TAPE MEDIA 132 can comprise any combination of commercial or custom devices adhering to LTFS or equivalent tape media standards.

In one embodiment of the present invention, COMPUTER SYSTEM 120 comprises MOUNT MEMORY 122 and SELECTIVE LTFS MOUNT 124.

In one embodiment of the present invention, MOUNT MEMORY 122 can be a plurality of MOUNT MEMORIES 122 within COMPUTER SYSTEM 120. MOUNT MEMORY 122 can be system memory comprising information such as, but not limited to, file/directory structure and file data copied from TAPE MEDIA 132 during SELECTIVE LTFS MOUNT 124 operation.

In one embodiment of the present invention, SELECTIVE LTFS MOUNT 124 can be a plurality of SELECTIVE LTFS MOUNTS 124 within COMPUTER SYSTEM 120.

SELECTIVE LTFS MOUNT 124 can receive search input and/or parameters (e.g., a file/directory selection) to be mounted from TAPE MEDIA 132 and performs selective file/directory mounting toward MOUNT MEMORY 122. In embodiments of the present invention, SELECTIVE LTFS MOUNT 124 can comprise any combination of commercial or custom devices and/or software products associated with operating selective file/directory mounting.

In one embodiment of the present invention, SELECTIVE LTFS MOUNT 124 comprises LTFS MOUNT 126 and INDEX SEARCH 128. LTFS MOUNT 126 can be operate mounting related data flow between TAPE DRIVE 130 and MOUNT MEMORY 122 whereas INDEX SEARCH 128 can operate LTFS MOUNT 126 to limit LTFS MOUNT 126 operation to mounting one or more selective files/directories. In another embodiment of the present invention, SELECTIVE LTFS MOUNT 124 can integrate LTFS MOUNT 126 and INDEX SEARCH 128 to operate selective file/directory mounting of TAPE MEDIA 132.

In one embodiment of the present invention, LTFS MOUNT 126 can be a plurality of LTFS MOUNTS 126 within SELECTIVE LTFS MOUNT 124. LTFS MOUNT 126 can read LTFS Index metadata and send file/directory structure toward MOUNT MEMORY 122. LTFS MOUNT 126 can create and send selective file structures toward MOUNT MEMORY 122 based on INDEX SEARCH 128 results. In embodiments of the present invention, LTFS MOUNT 126 can comprise any combination of commercial or custom devices and/or software products associated with mounting LTFS media (TAPE MEDIA 132).

In one embodiment of the present invention, INDEX SEARCH 128 can be a plurality of INDEX SEARCHES 128 within SELECTIVE LTFS MOUNT 124. INDEX SEARCH 128 can parse and search LTFS Index metadata used to select one or more files/directories for mounting based on received search input. Parsing of LTFS Index metadata can identify groupings of metadata elements, tagged with identifiers such as, but not limited to, file ID, directory ID, filename, directory name, filename to directory relationship identifier, UUID, partition ID and extent information. Search input can comprise information such as, but not limited to, one or more directories, one or more files and one or more dates/times. Further, search parameters can be received as search input modifiers and can be based on attributes such as, but not limited to, “wild cards” and date/time ranges. Embodiments can represent “wild cards” by attributes such as, but not limited to, special characters to substitute characters, numbers, date/time values and ranges. As INDEX SEARCH 128 finds one or more file/directory meeting received search input and/or search parameters, INDEX SEARCH 128 receives related file structure information and sends file structure data toward LTFS MOUNT 126. In embodiments of the present invention, INDEX SEARCH 128 can comprise any combination of commercial or custom devices and/or software products associated with operating INDEX SEARCH 128.

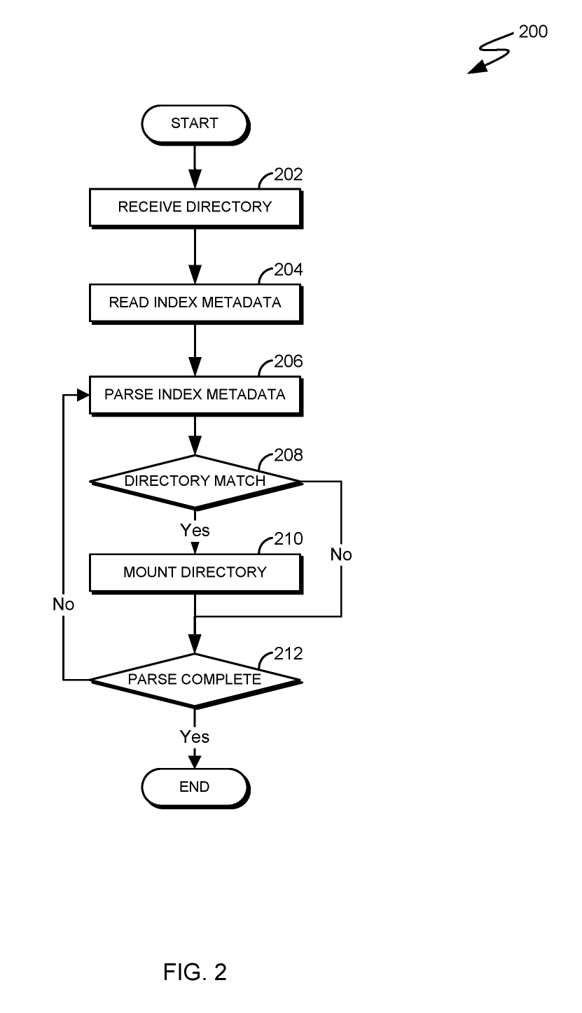

FIG. 2 illustrates a flowchart of LTFS selective file and directory tape mounting, in accordance with an embodiment of the present invention. LTFS selective file and directory tape mounting 200, comprises operations RECEIVE DIRECTORY 202, READ INDEX METADATA 204, PARSE INDEX METADATA 206, DIRECTORY MATCH 208, MOUNT DIRECTORY 210 and PARSE COMPLETE 212.

Operation RECEIVE DIRECTORY 202, can receive one or more file/directory input and/or search attributes by SELECTIVE LTFS MOUNT 124 to mount from TAPE MEDIA 132.

In operation READ INDEX METADATA 204, LTFS MOUNT 126 can read an LTFS Index file from an LTFS Index partition (IP) comprising a current LTFS tape media file/directory contents.

In operation PARSE INDEX METADATA 206, INDEX SEARCH 128 can parse and search the received LTFS Index metadata for the received one or more file/directory based search attributes.

In decision operation, DIRECTORY MATCH 208, if one or more file/directory being searched for are found from operation PARSE INDEX METADATA 206, INDEX SEARCH 128 receives related file structure information and passes control toward operation MOUNT DIRECTORY 210, otherwise control is passed toward operation PARSE COMPLETE 212.

Operation MOUNT DIRECTORY 210, can execute mounting of found, one or more file/directory structures in operation PARSE INDEX METADATA 206. LTFS MOUNT 126 receives a selective file/directory and related file structure information from INDEX SEARCH 128 to create each portion of a selective file structure information found. The selective file structure is generated in MOUNT MEMORY 122 where the mounting operation can comprise actions such as, but not limited to, copying file/directory structure information from the LTFS Index metadata toward MOUNT MEMORY 122 and enabling a file system interface.

Operation, PARSE COMPLETE 212, is a decision operation that can determine when the LTFS Index metadata file parse process is complete by INDEX SEARCH 128. If all file/directory contents have been parsed, then processing ends, otherwise control passes toward operation PARSE INDEX METADATA 206. It should be noted that an operation to unmount a directory (not depicted) can comprise actions to re-write the LTFS Index metadata at the beginning of the IP. In this case the original LTFS Index metadata can operate a modified sync action and/or unmount operation as described earlier in this specification.

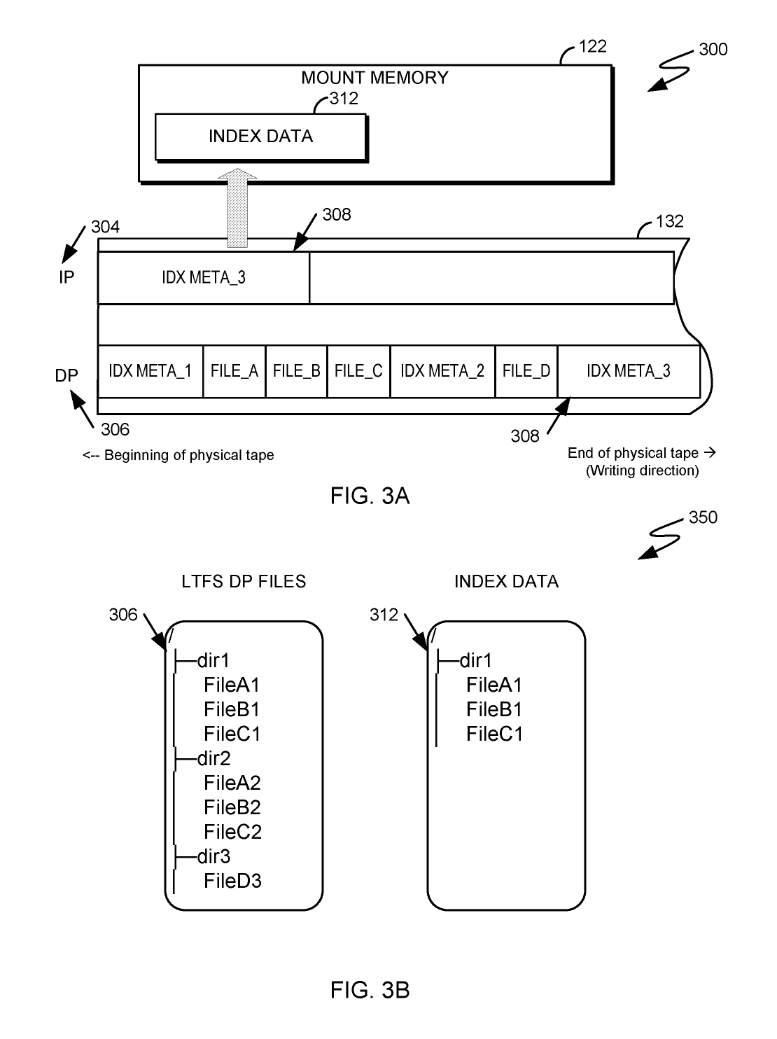

FIG. 3A illustrates physical tape media organization with selective file index mounting, in accordance with an embodiment of the present invention. The LTFS tape illustration 300 represents LTFS physical tape structure and tape mounting and comprises items TAPE MEDIA 132, IP 304, DP 306, IDX META_3 308 and MOUNT MEMORY 122.

Item TAPE MEDIA 132 can represent a portion of a physical LTFS tape media as described in FIG. 1. TAPE MEDIA 132 comprises item IP 304, Index Partition and item DP 306, Data Partition. When an LTFS tape is written to, files are stored toward the end of the tape media. When an LTFS tape is synchronized, the sync action creates an LTFS Index metadata file comprising all active directories and/or file information and writes the LTFS Index metadata file to the end of the DP 306 (e.g., item IDX META_3 308). Further, when the LTFS tape media is unmounted, the current LTFS Index metafile is written to IP 304 toward the beginning of the physical tape media (e.g., item IDX META_3 308). It should be noted that item DP 306 depicts ‘IDX META_1’ and ‘IDX META_2’, which indicate prior sync actions of former data states of TAPE MEDIA 132 content.

Item MOUNT MEMORY 122 can represent MOUNT MEMORY 122 as described in FIG. 1 and comprises item INDEX DATA 312. As SELECTIVE LTFS MOUNT 124 operates on item IDX META_3 308, found files/directories are loaded to INDEX DATA 312. It should be noted that INDEX DATA 312 files/directories can be viewed by USER APPLICATION(S) 112. When a file is selected (e.g., to be opened) from INDEX DATA 312 and is read by USER APPLICATION(S) 112, the mounted physical LTFS tape is advanced/rewound to an identified tape location (e.g., data extent) and the file is read from DP 306.

FIG. 3B illustrates a comparison of LTFS tape media file structure and LTFS selective file/directory tape mounted structure, in accordance with an embodiment of the present invention. The file structures 350, represent LTFS tape media and mounted files comprising item DP 306 and item INDEX DATA 312.

Item DP 306 is a sample illustration of a file structure that can be stored on FIG. 3A, item TAPE MEDIA 132 and comprised in item DP 306. From the illustration, a sample range of directories and files are shown. Item INDEX DATA 312 can illustrate a resulting directory and file structure from operation of embodiments of the present invention (e.g., SELECTIVE LTFS MOUNT 124). It should be noted that operation of embodiments of the present invention can reduce LTFS mount time by approximately fifty percent. For example, an embodiment of the present invention used to selectively mount one thousand files from LTFS tapes comprising file counts ranging one million and ten million files resulted in consistent mount time reduction performance.

FIG. 4 illustrates a block diagram of components of COMMUNICATION DEVICE 110, COMPUTER SYSTEM 120 and TAPE DRIVE 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for optimized selective file and directory tape mounting based on a Linear Tape File System (LTFS), the method comprising:
receiving, by a selective LTFS mount, LTFS Index metadata and one or more search inputs for searching for one or more files and directories;
parsing, by the selective LTFS mount, the LTFS Index metadata into one or more metadata elements to identify one or more file metadata and associated one or more directory metadata, one or more date metadata and one or more file structure metadata;
identifying, by the selective LTFS mount, one or more selective files by searching at least one of the one or more file metadata, the one or more directory metadata and the one or more date metadata based on matching the one or more search inputs;
responsive to identifying the one or more selective files, creating, by the selective LTFS mount, one or more selective file structure results based on combining the one or more selective files, the one or more directory metadata, the one or more date metadata and the one or more file structure metadata, respectively;
storing, by the selective LTFS mount, the one or more selective file structure results in mount memory; and
mounting, by the selective LTFS mount, the one or more selective file structure results, for access.

2. The method of claim 1, wherein the one or more search inputs comprise at least one of one or more filenames, one or more directory names and one or more dates/times.

3. The method of claim 1, further comprising:
receiving, by the selective LTFS mount, one or more search parameters associated with the one or more search inputs to be accessed.

4. The method of claim 3, wherein the one or more search parameters comprise at least one of one or more wild cards based on at least one of a substitution of one or more characters, one or more numbers, one or more date/time values, one or more characters range, one or more numbers range and one or more date/time range for identifying the one or more selective files.

5. The method of claim 1, wherein the one or more file structure metadata comprises at least one of one or more Universally Unique Identifiers, one or more filename identifiers, one or more directory structure identifiers, one or more filename to directory relationship identifiers and one or more extent information.

6. The method of claim 1, further comprising:
unmounting, by the selective LTFS mount, wherein the one or more selective file structure results replaces portions of the one or more file metadata associated with the LTFS Index metadata, creating a second LTFS Index metadata; and
synchronizing, by the selective LTFS mount, the second LTFS Index metadata to LTFS media.

7. The method of claim 1, wherein the mount memory enables access to one or more file system interfaces.

8. A computer program product for optimized selective file and directory tape mounting based on a Linear Tape File System (LTFS), the computer program product comprising:
one or more computer readable storage media and program instructions stored on the one or more computer readable storage media, the program instructions comprising:
program instructions to, receive, by a selective LTFS mount, LTFS Index metadata and one or more search inputs for searching for one or more files and directories;
program instructions to, parse, by the selective LTFS mount, the LTFS Index metadata into one or more metadata elements to identify one or more file metadata and associated one or more directory metadata, one or more date metadata and one or more file structure metadata;
program instructions to, identify, by the selective LTFS mount, one or more selective files by searching at least one of the one or more file metadata, the one or more directory metadata and the one or more date metadata based on matching the one or more search inputs;
program instructions to, respond to identifying the one or more selective files, creating, by the selective LTFS mount, one or more selective file structure results based on combining the one or more selective files, the one or more directory metadata, the one or more date metadata and the one or more file structure metadata, respectively;
program instructions to, store, by the selective LTFS mount, the one or more selective file structure results in mount memory; and
program instructions to, mount, by the selective LTFS mount, the one or more selective file structure results, for access.

9. The computer program product of claim 8, wherein the one or more search inputs comprise at least one of one or more filenames, one or more directory names and one or more dates/times.

10. The computer program product of claim 8, further comprising:
program instructions to, receive, by the selective LTFS mount, one or more search parameters associated with the one or more search inputs to be accessed.

11. The computer program product of claim 10, wherein the one or more search parameters comprise at least one of one or more wild cards based on at least one of a substitution of one or more characters, one or more numbers, one or more date/time values, one or more characters range, one or more numbers range and one or more date/time range for identifying the one or more selective files.

12. The computer program product of claim 8, wherein the one or more file structure metadata comprises at least one of one or more Universally Unique Identifiers, one or more filename identifiers, one or more directory structure identifiers, one or more filename to directory relationship identifiers and one or more extent information.

13. The computer program product of claim 8, further comprising:
program instructions to, unmount, by the selective LTFS mount, wherein the one or more selective file structure results replaces portions of the one or more file metadata associated with the LTFS Index metadata, creating a second LTFS Index metadata; and
program instructions to, synchronize, by the selective LTFS mount, the second LTFS Index metadata to LTFS media.

14. The computer program product of claim 8, wherein the mount memory enables access to one or more file system interfaces.

15. A computer system for optimized selective file and directory tape mounting based on a Linear Tape File System (LTFS), the computer system comprising:
one or more computer processors;
one or more computer readable storage media;
program instructions stored on the one or more computer readable storage media for execution by at least one of the one or more computer processors, the program instructions comprising:
program instructions to, receive, by a selective LTFS mount, LTFS Index metadata and one or more search inputs for searching for one or more files and directories;
program instructions to, parse, by the selective LTFS mount, the LTFS Index metadata into one or more metadata elements to identify one or more file metadata and associated one or more directory metadata, one or more date metadata and one or more file structure metadata;
program instructions to, identify, by the selective LTFS mount, one or more selective files by searching at least one of the one or more file metadata, the one or more directory metadata and the one or more date metadata based on matching the one or more search inputs;
program instructions to, respond to identifying the one or more selective files, creating, by the selective LTFS mount, one or more selective file structure results based on combining the one or more selective files, the one or more directory metadata, the one or more date metadata and the one or more file structure metadata, respectively;
program instructions to, store, by the selective LTFS mount, the one or more selective file structure results in mount memory; and
program instructions to, mount, by the selective LTFS mount, the one or more selective file structure results, for access.

16. The computer system of claim 15, wherein the one or more search inputs comprise at least one of one or more filenames, one or more directory names and one or more dates/times.

17. The computer system of claim 15, further comprising:
program instructions to, receive, by the selective LTFS mount, one or more search parameters associated with the one or more search inputs to be accessed.

18. The computer system of claim 17, wherein the one or more search parameters comprise at least one of one or more wild cards based on at least one of a substitution of one or more characters, one or more numbers, one or more date/time values, one or more characters range, one or more numbers range and one or more date/time range for identifying the one or more selective files.

19. The computer system of claim 15, wherein the one or more file structure metadata comprises at least one of one or more Universally Unique Identifiers, one or more filename identifiers, one or more directory structure identifiers, one or more filename to directory relationship identifiers and one or more extent information.

20. The computer system of claim 15, further comprising:
program instructions to, unmount, by the selective LTFS mount, wherein the one or more selective file structure results replaces portions of the one or more file metadata associated with the LTFS Index metadata, creating a second LTFS Index metadata; and
program instructions to, synchronize, by the selective LTFS mount, the second LTFS Index metadata to LTFS media.
